(19) United States
(12) Patent Application Publication
(10) Pub. No.: US 2009/0174384 A1
(43) Pub. Date: Jul. 9, 2009

(54) SWITCHING REGULATOR AND METHOD OF CONTROLLING THE SAME

(76) Inventors: Yuusuke Michishita, Osaka (JP); Junji Nishida, Osaka (JP)

Correspondence Address: DICKSTEIN SHAPIRO LLP, 1825 EYE STREET NW, Washington, DC, 20006-5403, US

(21) Appl. No.: 12/297,806

(22) PCT Filed: Feb. 5, 2008
(86) PCT No.: PCT/JP2008/052218

§ 371 Date: Oct. 20, 2008

(30) Foreign Application Priority Data
Mar. 15, 2007 (JP) 2007-066677

(51) Int. Cl. H02M 3/155

(52) U.S. Cl. 323/285

(57) ABSTRACT

A disclosed switching regulator converts an input voltage to an output voltage of a predetermined level and outputs the output voltage. The disclosed switching regulator includes a switching transistor configured to be turned on and off according to a control signal; an inductor configured to be charged by the input voltage when the switching transistor is turned on; a mode switching circuit configured to generate a switching signal for switching a control mode of the switching transistor between a PWM control mode and a VFM control mode; and a control circuit configured to control the switching transistor in the PWM control mode or the VFM control mode depending on the switching signal from the mode switching circuit so that the output voltage is maintained at the predetermined level.

### TECHNICAL FIELD

The present invention generally relates to a switching regulator and a method of controlling the switching regulator. More particularly, the present invention relates to a switching regulator capable of selecting a PWM control mode or a VFM control mode depending on a load level, and a method of controlling the switching regulator.

### BACKGROUND ART

In consideration of environmental problems, reducing power consumption of electronic devices is becoming more and more important. This trend is especially prominent in electronic devices driven by batteries. Generally, to reduce power consumption of an electronic device, it is important to improve the efficiency of its power supply circuit in addition to reducing power necessary to operate the electronic device.

As high-efficiency power supply circuits, non-isolated switching regulators employing inductors are widely used for small electronic devices. Switching regulators are normally controlled either by a pulse width modulation (PWM) method or a pulse frequency modulation (PFM) method. In the PWM method, the output voltage of a switching regulator is maintained at a predetermined level by changing the duty cycle of a clock pulse signal having a constant frequency. In the PFM method, the output voltage of a switching regulator is maintained at a predetermined level by changing the frequency of a clock pulse signal having a constant pulse width.

With the PWM method, since the switching transistor of a switching regulator is turned on and off at a constant frequency even at light load, the efficiency of the switching regulator becomes low when the electric current supplied to a load is small. On the other hand, with the PFM method, since the frequency of a signal for turning on and off the switching transistor of a switching regulator is changed according to a connected load, the efficiency of the switching regulator becomes higher at light load compared with the PWM method. Meanwhile, the PPM method increases the influence of noise and ripple on an electronic device.

For the above reasons, in a conventional switching regulator, a PWM control mode, where a switching transistor of the switching regulator is controlled based on the PWM method, or a PFM control mode, where the switching transistor is controlled based on the PFM method, is dynamically selected according to a load level to improve the power supply efficiency both at light load and heavy load.

FIG. 7 is a timing chart showing signals in a conventional switching regulator in the PFM control mode (see patent document 1).

As shown in FIG. 7, in the PFM control mode, a power TrSW signal (d) having a predetermined pulse width is generated based on a PFM reference clock (e) and results of comparing an error signal (b), which is generated from the difference between an output voltage of the conventional switching regulator and a predetermined reference voltage, with a PFM-control reference voltage (f).

FIG. 8 is a timing chart showing timings at which the PWM control mode and the PFM control mode are switched in the conventional switching regulator.

As shown in FIG. 8, the voltage level of the error signal (b) when the control mode is switched from the PWM control mode to the PFM control mode is different from that of the error signal (b) when the control mode is switched from the PFM control mode to the PWM control mode. When the power TrSW signal (d) is generated for a predetermined number of times in succession at a predetermined timing during the PFM control mode, the control mode is switched from the PFM control mode to the PWM control mode as shown in FIG. 7.

[Patent document 1] Japanese Patent No. 3647811

However, with a control method where the power TrSW signal (d) is generated based on the PFM reference clock (e) as described above, it is not possible to perform a switching operation until the next PFM control cycle comes even if the load changes. This in turn causes great distortion in the output voltage of the switching regulator.

### DISCLOSURE OF THE INVENTION

Embodiments of the present invention provide a switching regulator and a method of controlling the switching regulator that solve or reduce one or more problems caused by the limitations and disadvantages of the related art.

An embodiment of the present invention provides a switching regulator that converts an input voltage to an output voltage of a predetermined level and outputs the output voltage. The switching regulator includes a switching transistor configured to be turned on and off according to a control signal; an inductor configured to be charged by the input voltage when the switching transistor is turned on; a mode switching circuit configured to generate a switching signal for switching a control mode of the switching transistor between a PWM control mode and a VFM control mode; and a control circuit configured to control the switching transistor in the PWM control mode or the VFM control mode depending on the switching signal from the mode switching circuit so that the output voltage is maintained at the predetermined level; wherein the mode switching circuit is configured to detect a level of an inductor current flowing through the inductor based on a voltage at a junction between the switching transistor and the inductor and to generate the switching signal for switching the control mode from the PWM control mode to the VFM control mode depending on the detected level of the inductor current; and wherein, in the VFM control mode, the control circuit is configured to alternately turn on the switching transistor for a duration Ton and turn off the switching transistor for a duration Toff while a proportional voltage proportional to the output voltage is lower than a reference voltage.

Another embodiment of the present invention provides a method of controlling a switching regulator that converts an input voltage to an output voltage of a predetermined level and outputs the output voltage and that includes a switching transistor to be turned on and off according to a control signal and an inductor to be charged by the input voltage when the switching transistor is turned on. The method includes the steps of controlling the switching transistor in a control mode selected from a PWM control mode and a VFM control mode so that the output voltage is maintained at the predetermined level; detecting a level of an inductor current flowing through the inductor based on a voltage at a junction between the switching transistor and the inductor; and switching the control mode from the PWM control mode to the VFM control mode depending on the detected level of the inductor current; wherein, in the VFM control mode, the switching transistor is alternately turned on for a duration Ton and turned off for a duration Toff while a proportional voltage proportional to the output voltage is lower than a reference voltage.

### BRIEF DESCRIPTION OF THE DRAWINGS

FIG. 1 is a drawing illustrating an exemplary configuration of a switching regulator 1 according to a first embodiment of the present invention;

FIG. 2 is a timing chart of signals in the switching regulator 1 in a VFM control mode;

FIG. 3 is a timing chart of signals in the switching regulator 1 when the control mode is switched from the VFM control mode to the PWM control mode;

FIG. 4 is a timing chart of signals in a switching regulator 1a in the VFM control mode according to a second embodiment of the present invention;

FIG. 5 is a drawing illustrating an exemplary configuration of a switching regulator 1b according to a third embodiment of the present invention;

FIG. 6 is a timing chart of signals in the switching regulator 1b in the VFM control mode;

FIG. 7 is a timing chart showing signals in a conventional switching regulator in the PFM control mode; and

FIG. 8 is a timing chart showing timings at which the PWM control mode and the PFM control mode are switched in the conventional switching regulator.

### BEST MODE FOR CARRYING OUT THE INVENTION

Preferred embodiments of the present invention are described below with reference to the accompanying drawings.

### First Embodiment

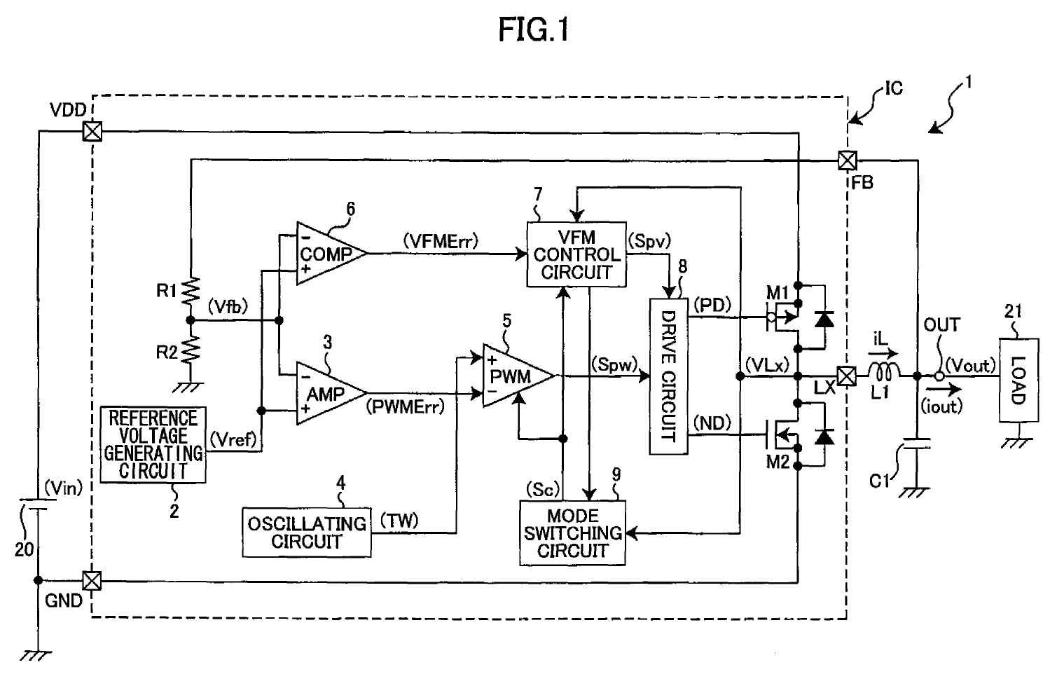

FIG. 1 is a drawing illustrating an exemplary configuration of a switching regulator 1 according to a first embodiment of the present invention.

The switching regulator 1 is a step-down switching regulator employing an inductor. The switching regulator 1 generates a voltage of a predetermined level from an input voltage Vin supplied from a direct power supply 20 and input from a terminal VDD, and outputs the generated voltage as an output voltage Vout from an output terminal OUT to a load 21.

The switching regulator 1 includes a switching transistor M1 implemented by a PMOS transistor that performs a switching operation for output control of the input voltage Vin, a synchronous rectifier transistor M2 implemented by an NMOS transistor, resistors R1 and R2 for obtaining a divided voltage Vfb (a voltage proportional to the output voltage Vout) that is a fraction of the output voltage Vout, and a reference voltage generating circuit 2 for generating a reference voltage Vref. The switching regulator 1 also includes a difference amplifier circuit 3 that amplifies the voltage difference between the divided voltage Vfb and the reference voltage Vref and outputs the amplified voltage difference as a signal PWMErr, an oscillating circuit 4 for generating a triangular wave signal TW, and a PWM comparator 5 that generates a pulse signal Spw used in the PWM control mode from the signal PWMErr and the triangular wave signal TW.

The switching regulator 1 also includes a variable frequency modulation (VFM) comparator 6 that compares the divided voltage Vfb and the reference voltage Vref and generates a binary signal VFMErr indicating the comparison result, a VFM control circuit 7 that generates a control signal Spv according to the signal VFMErr, and a drive circuit 8 that controls the switching transistor M1 and the synchronous rectifier transistor M2 according to the pulse signal Spw and the control signal Spv. The switching regulator 1 further includes a mode switching circuit 9 that exclusively selects and activates the PWM comparator 5 or the VFM control circuit 7, an inductor L1, and a smoothing output capacitor C1. In FIG. 1, a parasitic diode is connected in parallel with each of the switching transistor M1 and the synchronous rectifier transistor M2.

In the present application, the reference voltage generating circuit 2, the difference amplifier circuit 3, the oscillating circuit 4, the PWM comparator 5, the VFM comparator 6, the VFM control circuit 7, the drive circuit 8, and the resistors R1 and R2 may be collectively called a control circuit. In the switching regulator 1, components other than the inductor L1 and the output capacitor C1 are integrated as one IC. The IC has terminals VDD, LX, FB, and GND. The terminal VDD is the input terminal of the switching regulator 1 and the terminal GND is connected to ground potential.

The direct power supply 20 is connected between the terminal VDD and the terminal GND and supplies the input voltage Vin to the terminal VDD. The load 21 is connected between the output terminal OUT and ground potential. The switching transistor M1 is connected between the terminal VDD and the terminal LX, and the synchronous rectifier transistor M2 is connected between the terminal LX and the terminal GND. The inductor L1 is connected between the terminal LX and the output terminal OUT, and the output capacitor C1 is connected between the output terminal OUT and ground potential. The inductor L1 is charged when the switching transistor M1 is turned on. The junction between the inductor L1 and the output capacitor C1, i.e., the output terminal OUT, is connected to the terminal FB, and a series circuit of the resistors R1 and R2 is connected between the terminal FB and ground potential.

The junction between the resistors R1 and R2 is connected to the respective inverting inputs of the difference amplifier circuit 3 and the VFM comparator 6. The reference voltage Vref is input to the respective non-inverting inputs of the difference amplifier circuit 3 and the VFM comparator 6. The signal PWMErr output from the difference amplifier circuit 3 is input to the inverting input of the PWM comparator 5, and the triangular wave signal TW output from the oscillating circuit 4 is input to the non-inverting input of the PWM comparator 5. The PWM comparator 5 generates the pulse signal Spw from the signal PWMErr and the triangular wave signal TW. The signal VFMErr output from the VFM comparator 6 is input to the VFM control circuit 7. The VFM control circuit 7 generates the control signal Spv based on the signal VFMErr. The pulse signal Spw and the control signal Spv are input to the drive circuit 8.

The drive circuit 8 outputs a control signal PD for switching the switching transistor M1 to the gate of the switching transistor M1 and outputs a control signal ND for switching the synchronous rectifier transistor M2 to the gate of the synchronous rectifier transistor M2. A switching signal Sc from the mode switching circuit 9 is input to the PWM comparator 5 and the VFM control circuit 7. A voltage VLx at the terminal LX (or a junction between the switching transistor M1 and the inductor L1) is input to the VFM control circuit 7 and the mode switching circuit 9.

With the above configuration, the mode switching circuit 9 controls the PWM comparator 5 and the VFM control circuit 7 so that the switching transistor M1 is controlled in a variable frequency modulation (VFM) control mode described later when an output current iout output from the output terminal OUT is small (at light load) and the switching transistor M1 is controlled in the PWM control mode when the output current iout is large (at heavy load). The mode switching circuit 9 determines whether to switch the control mode from the PWM control mode to the VFM control mode based on the voltage VLx, and determines whether to switch the control mode from the VFM control mode to the PWM control mode based on the number of successive pulses of the control signal Spv output from the VFM control circuit 7. For example, if the voltage VLx becomes zero, the mode switching circuit 9 assumes that an inductor current iL flowing through the inductor L1 has become zero and determines to switch the control mode from the PWM control mode to the VFM control mode.

After determining to switch the control mode from the PWM control mode to the VFM control mode, the mode switching circuit 9 deactivates the PWM comparator 5 and activates the VFM control circuit 7. Meanwhile, after outputting a predetermined number of pulses as the control signal Spv for turning on the switching transistor M1, the VFM control circuit 7 outputs a signal to the mode switching circuit 9. When receiving the signal from the VFM control circuit 7, the mode switching circuit 9 activates the PWM comparator 5 and deactivates the VFM control circuit 7.

During the PWM control mode, as the output voltage Vout of the switching regulator 1 increases, the signal PWMErr output from the difference amplifier circuit 3 decreases and the duty cycle of the pulse signal Spw output from the PWM comparator 3 decreases. As a result, the duration that the switching transistor M1 is turned on decreases and the output voltage Vout of the switching regulator 1 is decreased. On the other hand, if the output voltage Vout of the switching regulator 1 decreases, the opposite of the above process occurs, so that the level of the output voltage Vout is maintained.

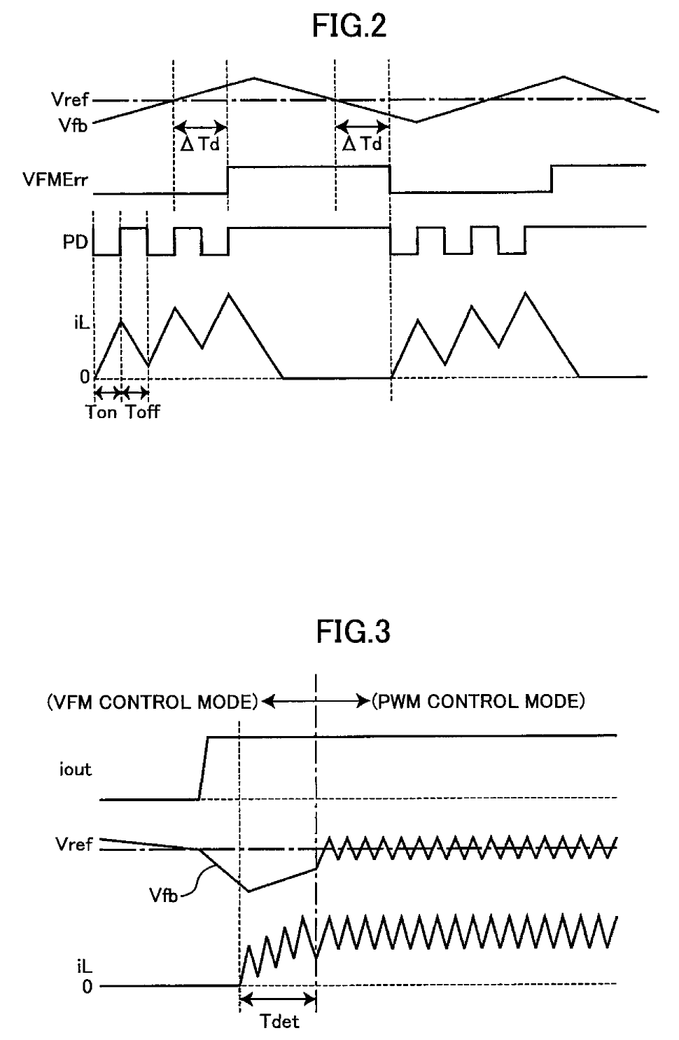

Next, an exemplary control process in the switching regulator 1 in the VFM control mode is described with reference to FIG. 2. FIG. 2 is a timing chart of signals in the switching regulator 1 in the VFM control mode.

When the divided voltage Vfb becomes equal to or higher than the reference voltage Vref, the VFM comparator 6 changes the signal VFMErr to the high level after a delay time ΔTd. While the signal VFMErr is at the high level, the VFM control circuit 7 maintains the control signal Spv at the high level. While the control signal Spv is at the high level, the driver circuit 8 turns off the switching transistor M1 and turns on the synchronous rectifier transistor M2. As a result, the inductor current iL gradually decreases and becomes zero.

On the other hand, when the divided voltage Vfb becomes lower than the reference voltage Vref, the VFM comparator 6 changes the signal VFMErr to the low level after the delay time ΔTd. While the signal VFMErr is at the low level, the VFM control circuit 7 generates a pulse signal that alternately becomes high and low for predetermined periods of time, and outputs the generated pulse signal as the control signal Spv. The driver circuit 8 turns off the switching transistor M1 and turns on the synchronous rectifier transistor M2 when the control signal Spv is at the high level; and turns on the switching transistor M1 and turns off the synchronous rectifier transistor M2 when the control signal Spv is at the low level.

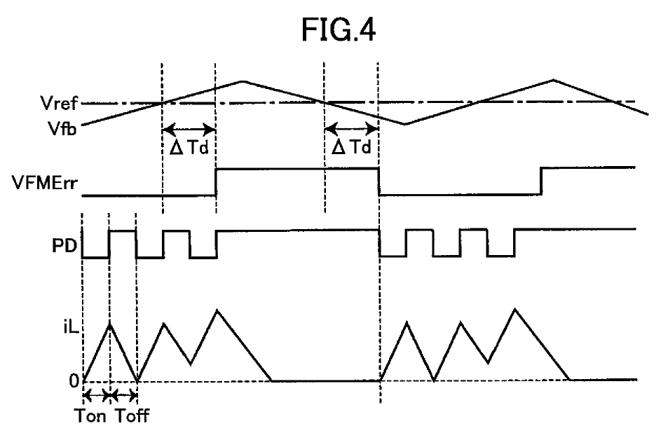

In FIG. 2, the duration that the switching transistor M1 is turned on is indicated by Ton and the duration that the switching transistor M1 is turned off is indicated by Toff. As shown in FIG. 2, the VFM control circuit 7 generates a pulse signal that alternately becomes low for the duration Ton and becomes high for the duration Toff while the signal VFMErr is at the low level and outputs the generated pulse signal as the control signal Spv. The duration Ton and the duration Toff are determined so that the inductor current iL does not fall to zero. Also, the VFM control circuit 7 counts the number of low level pulses in the generated control signal Spv and outputs a signal to the mode switching circuit 9 when the number of low level pulses reaches a predetermined value (e.g., four). When receiving the signal from the VFM control circuit 7, the mode switching circuit 9 activates the PWM comparator 5 and deactivates the VFM control circuit 7 to switch the control mode from the VFM control mode to the PWM control mode. FIG. 3 is a timing chart of signals in the switching regulator 1 when the control mode is switched from the VFM control mode to the PWM control mode.

Thus, in the VFM control mode of the switching regulator 1 of the first embodiment, the VFM control circuit 7 outputs a pulse signal as the control signal Spv that alternately becomes low for the duration Ton and becomes high for the duration Toff while the signal VFMErr from the VFM comparator 6 is at the low level; thereby causes the drive circuit 8 to complementarily turn the switching transistor M1 and the synchronous rectifier transistor M2 on and off; and causes the mode switching circuit 9 to switch the control mode from the VFM control mode to the PWM control mode after the switching transistor M1 and the synchronous rectifier transistor M2 are turned on and off for a predetermined number of times in succession. This configuration makes it possible to switch the control modes of a switching regulator according to a load level without causing great distortion in the output voltage of the switching regulator and thereby to improve the power supply efficiency both at light load and heavy load.

### Second Embodiment

As described above, in the VFM control mode of the switching regulator 1 of the first embodiment, the VFM control circuit 7 outputs a pulse signal as the control signal Spv that alternately becomes low for the duration Ton and becomes high for the duration Toff; and the duration Ton and the duration Toff are determined so that the inductor current iL does not fall to zero (so that the inductor current iL continues to flow) while the divided voltage Vfb is lower than the reference voltage Vref. In a second embodiment of the present invention, the switching transistor M1 is turned on and off for a first time when the divided voltage Vfb becomes lower than the reference voltage Vref, and is turned on and off for a second time when the inductor current iL becomes zero.

In the second embodiment, a switching regulator 1a is used instead of the switching regulator 1. The switching regulator 1a has substantially the same configuration as that of the switching regulator 1 except that a VFM control circuit 7a is provided instead of the VFM control circuit 7. Therefore, the drawing of the switching regulator 1a and descriptions of the components corresponding to those in the switching regulator 1 are omitted. In the present application, the reference voltage generating circuit 2, the difference amplifier circuit 3, the oscillating circuit 4, the PWM comparator 5, the VFM comparator 6, the VFM control circuit 7a, the drive circuit 8, and the resistors R1 and R2 may be collectively called a control circuit.

An exemplary control process in the switching regulator 1a in the VFM control mode is described below with reference to FIG. 4. FIG. 4 is a timing chart of signals in the switching regulator 1a in the VFM control mode.

When the signal VFMErr falls to the low level, the VFM control circuit 7a outputs the control signal Spv to cause the drive circuit 8 to turn on the switching transistor M1 for a predetermined period of time, and after the predetermined period of time, outputs the control signal Spv to cause the drive circuit 8 to turn off the switching transistor M1. Then, when detecting that the inductor current iL has become zero based on the voltage VLx at the terminal LX (e.g., when the voltage VLx becomes zero), the VFM control circuit 7 outputs the control signal Spv to cause the drive circuit 8 to turn on the switching transistor M1 again. After that, the VFM control circuit 7a outputs the control signal Spv to cause the drive circuit 8 to complementarily turn the switching transistor M1 and the synchronous rectifier transistor M2 on and off so that the inductor current iL does not become zero as in the first embodiment.

If the switching transistor M1 is turned on and off in such a manner that the inductor current iL continues to flow even when the output current iout is small, the loss of [inductor current×on-resistance of switching transistor] increases and the ripple voltage in the output voltage Vout also increases. Starting the second switching cycle after detecting that the inductor current iL has become zero makes it possible to reduce the power loss resulting from the continuous flow of the inductor current iL.

Thus, the switching regulator 1a of the second embodiment provides the advantageous effects of the switching regulator 1 of the first embodiment and also makes it possible to reduce the power loss that is caused by the inductor current iL continuing to flow even at light load.

### Third Embodiment

In the first and second embodiments described above, the duration Ton and the duration Toff are determined regardless of the level of the input voltage Vin. In a third embodiment of the present invention, the duration Toff is changed according to the level of the input voltage Vin.

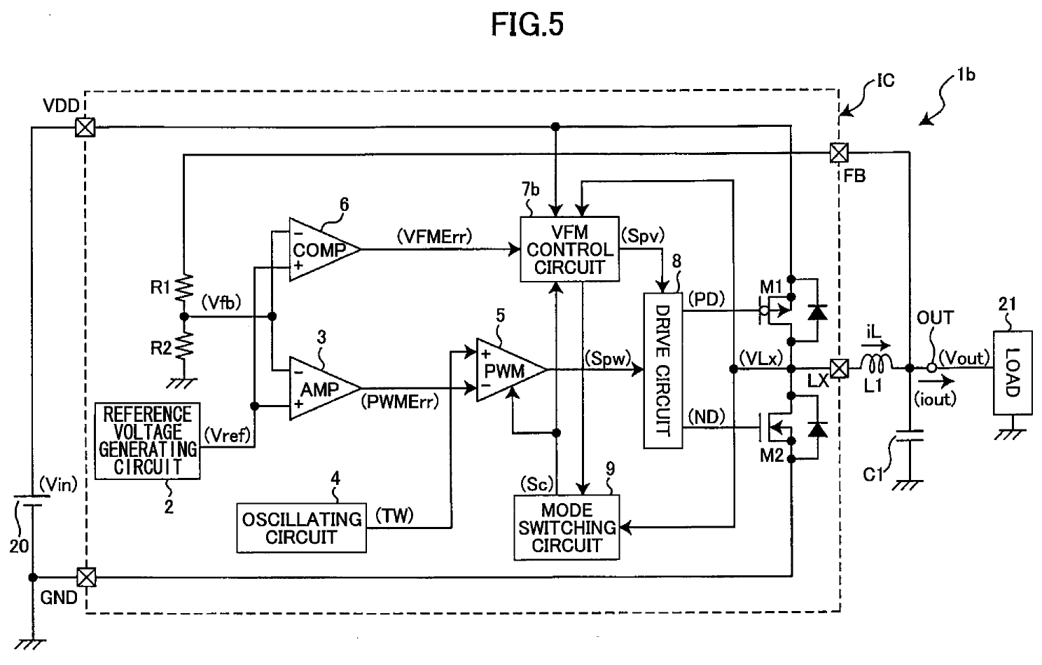

FIG. 5 is a drawing illustrating an exemplary configuration of a switching regulator 1b according to the third embodiment of the present invention. Components of the switching regulator 1b shown in FIG. 5 that correspond to those of the switching regulator 1 shown in FIG. 1 are assigned the same reference numbers and descriptions of those components are omitted. Here, differences between the switching regulator 1 and the switching regulator 1b are mainly discussed.

In the switching regulator 1b, the VFM control circuit 7 of the switching regulator 1 is replaced with a VFM control circuit 7b. The VFM control circuit 7b monitors the input voltage Vin and reduces the duration Toff if the input voltage Vin becomes lower than a predetermined level. In the present application, the reference voltage generating circuit 2, the difference amplifier circuit 3, the oscillating circuit 4, the PWM comparator 5, the VFM comparator 6, the VFM control circuit 7b, the drive circuit 8, and the resistors R1 and R2 may be collectively called a control circuit.

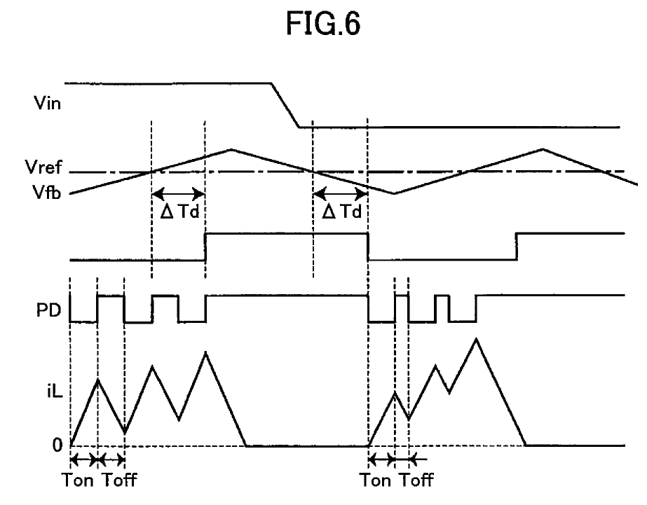

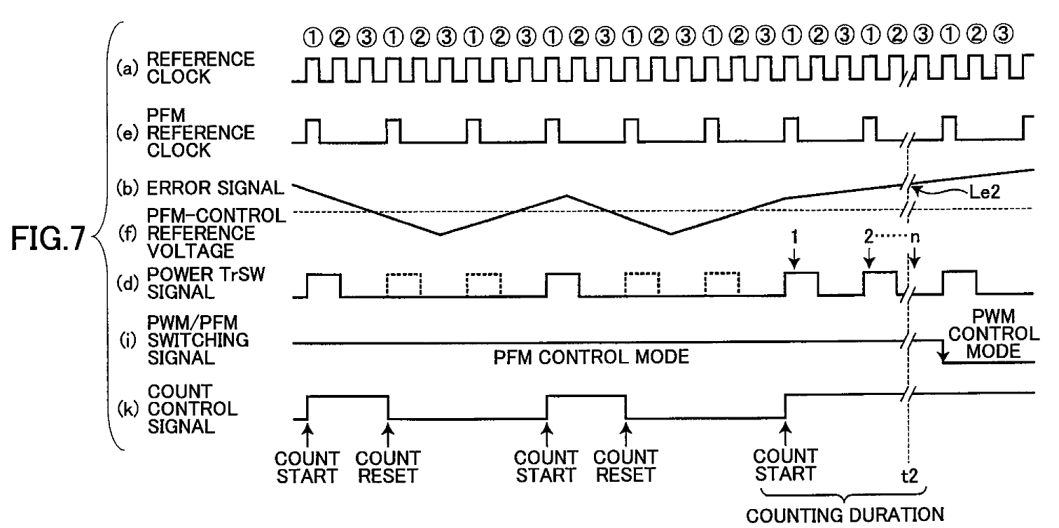

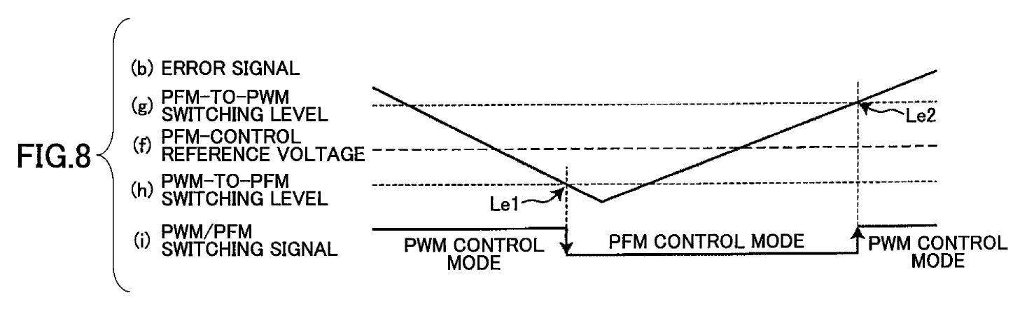

An exemplary control process in the switching regulator 1b in the VFM control mode is described below with reference to FIG. 6. FIG. 6 is a timing chart of signals in the switching regulator 1b in the VFM control mode.

If the input voltage Vin fluctuates, the peak current of the inductor current iL fluctuates. As a result, the loss of [inductor current iL×on-resistance of switching transistor M1] increases and the ripple voltage in the output voltage Vout also increases. As shown in FIG. 6, the VFM control circuit 7b performs a control process in substantially the same manner as in the first embodiment using a longer duration Toff when the input voltage Vin is equal to or higher than a predetermined level and using a shorter duration Toff when the input voltage Vin is lower than the predetermined level.

Thus, the switching regulator 1b of the third embodiment provides the advantageous effects of the switching regulators 1 and 1a of the first and second embodiments, and also makes it possible to prevent excessive flow of the inductor current iL by changing the duration Toff according to the level of the input voltage Vin and thereby to reduce the power loss resulting from the excessive flow of the inductor current iL.

The configuration of the third embodiment may also be applied to the second embodiment. In that case, the VFM control circuit 7b performs a control process in substantially the same manner as in the second embodiment using a longer duration Toff when the input voltage Vin is equal to or higher than a predetermined level and using a shorter duration Toff when the input voltage Vin is lower than the predetermined level.

In the above embodiments, it is assumed that the switching regulators 1, 1a, and 1b are step-down switching regulators. However, the present invention may also be applied to a step-up switching regulator.

Embodiments of the present invention provides a switching regulator and a method of controlling the switching regulator that can switch control modes according to a load level without causing great distortion in the output voltage and thereby to improve the power supply efficiency both at light load and heavy load.

An embodiment of the present invention provides a switching regulator that converts an input voltage and thereby outputs an output voltage of a predetermined level, and a method of controlling the switching regulator. In a VFM control mode of the switching regulator, a switching transistor is alternately turned on for a duration Ton and turned off for a duration Toff while a proportional voltage proportional to the output voltage is lower than a reference voltage. This configuration or the method makes it possible to switch control modes of a switching regulator according to a load level without causing great distortion in the output voltage and thereby to improve the power supply efficiency both at light load and heavy load.

According to another embodiment of the present invention, the switching regulator is configured to detect an inductor current flowing through an inductor based on a voltage at a junction between the inductor and the switching transistor, to turn on and off the switching transistor for a first time when the proportional voltage becomes lower than the reference voltage, and to start turning on and off the switching regulator for a second time when the inductor current becomes zero and the proportional voltage is still lower than the reference voltage. This configuration makes it possible to reduce the power loss caused by the inductor current iL continuing to flow even at light load.

According to still another embodiment of the present invention, the switching regulator is configured to change the duration Toff according to the level of the input voltage. More specifically, when the input voltage is equal to or higher than a predetermined level, the switching regulator makes the duration Toff longer than that used when the input voltage is lower than the predetermined level. This configuration makes it possible to prevent excessive flow of the inductor current and thereby to reduce the power loss resulting from the excessive flow of the inductor current.

The present invention is not limited to the specifically disclosed embodiments, and variations and modifications may be made without departing from the scope of the present invention.

The present application is based on Japanese Priority Application No. 2007-066677, filed on Mar. 15, 2007, the entire contents of which are hereby incorporated herein by reference.

1. A switching regulator that converts an input voltage to an output voltage of a predetermined level and outputs the output voltage, comprising:
a switching transistor configured to be turned on and off according to a control signal;
an inductor configured to be charged by the input voltage when the switching transistor is turned on;
a mode switching circuit configured to generate a switching signal for switching a control mode of the switching transistor between a PWM control mode and a VFM control mode; and
a control circuit configured to control the switching transistor in the PWM control mode or the VFM control mode depending on the switching signal from the mode switching circuit so that the output voltage is maintained at the predetermined level;
wherein the mode switching circuit is configured to detect a level of an inductor current flowing through the inductor based on a voltage at a junction between the switching transistor and the inductor and to generate the switching signal for switching the control mode from the PWM control mode to the VFM control mode depending on the detected level of the inductor current; and
wherein, in the VFM control mode, the control circuit is configured to alternately turn on the switching transistor for a duration Ton and turn off the switching transistor for a duration Toff while a proportional voltage proportional to the output voltage is lower than a reference voltage.

2. The switching regulator as claimed in claim 1,
wherein the control circuit is configured to output a signal to the mode switching circuit after turning on and off the switching transistor in succession for a predetermined number of times in the VFM control mode; and
wherein when receiving the signal from the control circuit, the mode switching circuit is configured to output the switching signal to the control circuit to switch the control mode from the VFM control mode to the PWM control mode.

3. The switching regulator as claimed in claim 1, wherein, in the VFM control mode, the control circuit is configured to set the duration Toff such that the inductor current continues to flow while the proportional voltage is lower than the reference voltage.

4. The switching regulator as claimed in claim 1, wherein, in the VFM control mode, the control circuit is configured to detect the level of the inductor current flowing through the inductor based on the voltage at the junction between the switching transistor and the inductor; and is configured to turn on and off the switching transistor for a first time when the proportional voltage becomes lower than the reference voltage and to start turning on and off the switching regulator for a second time when the inductor current becomes zero and the proportional voltage is still lower than the reference voltage.

5. The switching regulator as claimed in claim 1, wherein, in the VFM control mode, the control circuit is configured to change the duration Toff according to a level of the input voltage.

6. The switching regulator as claimed in claim 5, wherein when the input voltage becomes equal to or higher than a specified level in the VFM control mode, the control circuit is configured to make the duration Toff longer than that used when the input voltage is lower than the specified level.

7. The switching regulator as claimed in claim 1, wherein the switching transistor, the mode switching circuit, and the control circuit are integrated as one IC.

8. A method of controlling a switching regulator that converts an input voltage to an output voltage of a predetermined level and outputs the output voltage and that includes a switching transistor to be turned on and off according to a control signal and an inductor to be charged by the input voltage when the switching transistor is turned on, the method comprising the steps of:
controlling the switching transistor in a control mode selected from a PWM control mode and a VFM control mode so that the output voltage is maintained at the predetermined level;
detecting a level of an inductor current flowing through the inductor based on a voltage at a junction between the switching transistor and the inductor; and
switching the control mode from the PWM control mode to the VFM control mode depending on the detected level of the inductor current;
wherein, in the VFM control mode, the switching transistor is alternately turned on for a duration Ton and turned off for a duration Toff while a proportional voltage proportional to the output voltage is lower than a reference voltage.

9. The method as claimed in claim 8, wherein, the control mode is switched from the VFM control mode to the PWM control mode after the switching transistor is turned on and off in succession for a predetermined number of times in the VFM control mode.

10. The method as claimed in claim 8, wherein, in the VFM control mode, the duration Toff is set such that the inductor current continues to flow while the proportional voltage is lower than the reference voltage.

11. The method as claimed in claim 8, wherein, in the VFM control mode, the switching transistor is turned on and off for a first time when the proportional voltage becomes lower than the reference voltage and is started to be turned on and off for a second time when the inductor current becomes zero and the proportional voltage is still lower than the reference voltage.

12. The method as claimed in claim 8, wherein, in the VFM control mode, the duration Toff is changed according to a level of the input voltage.

13. The method as claimed in claim 12, wherein when the input voltage becomes equal to or higher than a specified level in the VFM control mode, the duration Toff is made longer than that used when the input voltage is lower than the specified level.
